(19) United States
(12) Patent Application Publication
(10) Pub. No.: US 2025/0225618 A1
(43) Pub. Date: Jul. 10, 2025

(54) IMAGE PROCESSING METHOD AND APPARATUS, AND STORAGE MEDIUM AND ELECTRONIC DEVICE

(71) Applicant: Beijing Bytedance Network Technology Co., Ltd., Shijingshan District, Beijing (CN)

(72) Inventors: Mengxi GUO, Beijing (CN); Shijie ZHAO, Beijing (CN); Yue LI, Los Angeles, CA (US); Junlin LI, Los Angeles, CA (US); Li ZHANG, Los Angeles, CA (US); Yue WANG, Beijing (CN)

(21) Appl. No.: 18/853,063

(22) PCT Filed: Mar. 14, 2023
(86) PCT No.: PCT/CN2023/081240

§ 371 Date: Sep. 30, 2024

(30) Foreign Application Priority Data
Apr. 11, 2022 (CN) 202210377047.4

(51) Int. Cl. G06T 5/20; G06T 3/40

(52) U.S. Cl. CPC G06T 5/20; G06T 3/40

(57) ABSTRACT

An image processing method and apparatus, and a storage medium and an electronic device are provided. The method includes: acquiring an original image, and extracting high-frequency information and low-frequency information in the original image; extracting content dependent information in the high-frequency information, and writing the content dependent information into the low-frequency information, to obtain a low-resolution image corresponding to the original image.

The present application claims priority of Chinese Patent Application No. 202210377047.4 filed to the Patent Office of China on Apr. 11, 2022, the disclosure of which is incorporated herein by reference in its entirety as part of the present application.

### TECHNICAL FIELD

Embodiments of the present disclosure relate to a field of computer data processing technology, for example, to an image processing method and apparatus, a storage medium and an electronic device.

### BACKGROUND

Resampling is usually required during storage, display, and transmission of digital images. On the one hand, resampled images may adapt to devices of different resolutions for better browsing images. On the other hand, images are downsampled, and the downsampled images are stored, transmitted, and then upsampled when displayed on terminal devices. A same set of models is adopted for forward downsampling and backward upsampling in the related technologies. During the implementation process, downsampling processing may lead to decrease in image resolution, thereby reducing storage and transmission costs. However, the above-described downsampling may also cause loss of high-frequency information in an image, resulting in loss of details in the reconstructed image of a low-resolution image during a subsequent upsampling process, thereby causing insufficient image details in a high-resolution image obtained from the low-resolution image after upsampling, which reduces image quality.

### SUMMARY

The embodiments of the present disclosure provide an image processing method and apparatus, a storage medium and an electronic device, to implement a low-resolution image obtained preserving content dependent information in an original image, thereby improving image quality while reducing the amount of image data.

In a first aspect, embodiments of the present disclosure provide an image processing method, and the method includes: acquiring an original image, and extracting high-frequency information and low-frequency information in the original image;

extracting content dependent information in the high-frequency information, and writing the content dependent information into the low-frequency information, to obtain a low-resolution image corresponding to the original image.

In a second aspect, embodiments of the present disclosure provide another image processing method, and the method includes: acquiring a low-resolution image, and extracting content dependent information in low-frequency information and high-frequency information based on the low-resolution image,

determining the high-frequency information based on the content dependent information, and fusing the high-frequency information and the low-frequency information to obtain the original image corresponding to the low-resolution image.

In a third aspect, embodiments of the present disclosure provide an image processing apparatus, and the apparatus includes: an information extraction model, configured to acquire an original image, and extract high-frequency information and low-frequency information in the original image;

a low-resolution image generating module, configured to extract content dependent information in the high-frequency information, and write the content dependent information into the low-frequency information, to obtain a low-resolution image corresponding to the original image.

In a fourth aspect, embodiments of the present disclosure provide another image

processing apparatus, and the apparatus includes: an information extraction model, configured to acquire a low-resolution image, and extract content dependent information in low-frequency information and high-frequency information based on the low-resolution image;

an original image generating module, configured to determine the high-frequency information based on the content dependent information, and fuse the high-frequency information and the low-frequency information to obtain the original image corresponding to the low-resolution image.

In a fifth aspect, embodiments of the present disclosure provide an electronic device,

and the electronic device includes:

one or more processors;

a storage apparatus, configured to store one or more programs,

The one or more programs, when executed by the one or more processors, cause the one or more processors to implement the image processing method of any one of the embodiments of the present disclosure.

In a sixth aspect, embodiments of the present disclosure provide a storage medium, including computer executable instructions. The computer executable instructions, when executed by a computer processor, are configured to execute the image processing method of any one of the embodiments of the present disclosure.

### BRIEF DESCRIPTION OF DRAWINGS

In the drawings throughout, same or similar drawing reference signs represent same or similar elements. It should be understood that the drawings are schematic, and originals and elements may not necessarily be drawn to scale.

FIG. 1 is a schematic flow chart of an image processing method provided by an embodiment of the present disclosure;

FIG. 2 is a schematic flow chart of space rearrangement provided by an embodiment of the present disclosure;

FIG. 3 is a schematic flow chart of another image processing method provided by an embodiment of the present disclosure;

FIG. 4 is a schematic flow chart of another image processing method provided by an embodiment of the present disclosure;

FIG. 5 is a structural schematic diagram of an image processing apparatus provided by an embodiment of the present disclosure;

FIG. 6 is a structural schematic diagram of another image processing apparatus provided by an embodiment of the present disclosure; and

FIG. 7 is a structural schematic diagram of an electronic device provided by an embodiment of the present disclosure.

### DETAILED DESCRIPTION

It should be understood that various steps recorded in the implementation modes of the method of the present disclosure may be performed according to different orders and/or performed in parallel. In addition, the implementation modes of the method may include additional steps and/or steps omitted or unshown. The scope of the present disclosure is not limited in this aspect.

The term “including” and variations thereof used in this article are open-ended inclusion, namely “including but not limited to”. The term “based on” refers to “at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

It should be noted that concepts such as “first” and “second” mentioned in the present disclosure are only used to distinguish different apparatuses, modules or units, and are not intended to limit orders or interdependence relationships of functions performed by these apparatuses, modules or units.

It should be noted that modifications of “one” and “more” mentioned in the present disclosure are schematic rather than restrictive, and those skilled in the art should understand that unless otherwise explicitly stated in the context, it should be understood as “one or more”.

In some embodiments, before transmitting or storing an image, an original image is downsampled to obtain a low-resolution image corresponding to the original image, thereby reducing the amount of data in original data. Further, the low-resolution image undergoes image transmission or image storage to reduce data resources occupied during transmission or storage, thereby reducing transmission or storage costs. For example, when the original image is displayed, the low-resolution image of the original image is acquired and upsampled to obtain a high-resolution image corresponding to the low-resolution image, so as to present a clearer image. In order to recover image details of the original image as much as possible in the upsampled high-resolution image, the method adopted in the related technologies when downsampling the original image in real-time, includes: mapping high-frequency information in the original image to a Gaussian distribution, so that image information on the Gaussian distribution may be extracted in a subsequent upsampling process to obtain a high-resolution image having more original image information. The applicant finds a plurality of limitations in the process of the above-described method, including: after obtaining the high-frequency information of the original image, the high-frequency information does not further undergo information separation according to image content; and none high-frequency information may be converted to an easily measurable Gaussian distribution without loss and reversibility; so content dependent information carried by the high-frequency information may be lost; and capability of the downsampled low-resolution image to invisibly store a large amount of information is ignored, so that image content information that may be used in the image during upsampling is too little and the recovered original image details are insufficient.

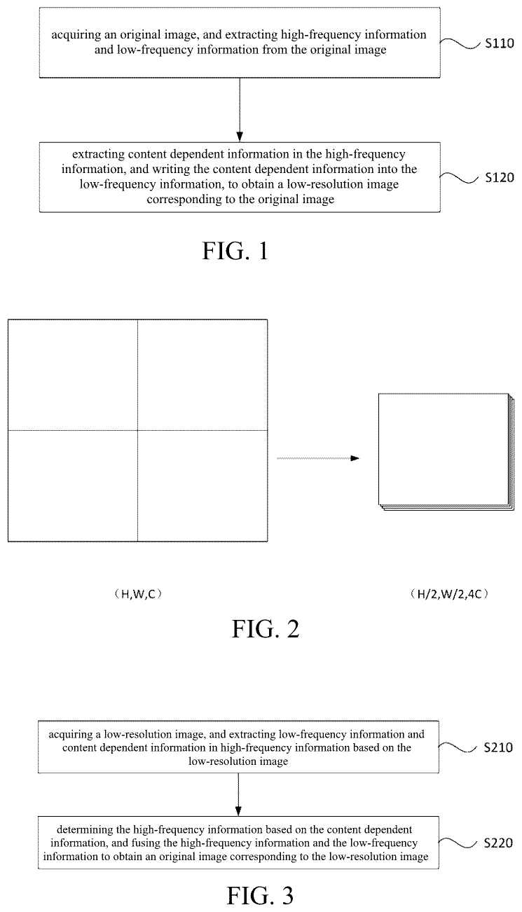

With respect to the above-described technical problems, in order to recover more details of the original image in the upsampled high-resolution image, an embodiment of the present disclosure provides a technical solution, referring to FIG. 1; and FIG. 1 is a schematic flow chart of an image processing method provided by an embodiment of the present disclosure. The embodiment of the present disclosure is suitable for downsampling and upsampling images, and the method may be executed by the image processing apparatus provided by the embodiment of the present disclosure. The image processing apparatus may be implemented in a form of software and/or hardware, for example, implemented through an electronic device; and the electronic device may be a mobile terminal or a PC terminal, etc. As shown in FIG. 1, the method according to this embodiment includes:

S110: acquiring an original image, and extracting high-frequency information and low-frequency information from the original image.

S120: extracting content dependent information in the high-frequency information, and writing the content dependent information into the low-frequency information, to obtain a low-resolution image corresponding to the original image.

In this embodiment, the original image to be processed is decomposed into the high-frequency information and the low-frequency information; after obtaining the high-frequency information of the original image, the high-frequency information is decomposed, to extract the content dependent information about the original image from the high-frequency information; the content dependent information is written as embedding information into the downsampled low-frequency information to obtain a low-resolution image of the original image, so that the low-resolution image includes more texture information; correspondingly, the high-frequency information related to the image content is obtained in the backward upsampling process, to accurately obtain a high-resolution image carrying more texture details, thereby improving image quality.

In the embodiment of the present disclosure, the original image may be understood as an unprocessed image. The low-resolution image may be understood as an image containing the image content of the original image and having a reduced amount of data.

For example, in order to obtain the low-resolution image of the original image, image information extraction needs to be firstly performed on the original image, to respectively extract the high-frequency information and the low-frequency information in the original image, wherein, the low-frequency information includes image content information, and the high-frequency information includes texture information such as edges.

In some embodiments, the method of extracting the high-frequency information and the low-frequency information in the original image may include: downsampling the original image to obtain the low-frequency information; determining initial high-frequency information based on the original image and a high-resolution low-frequency image obtained by upsampling the low-frequency information; rearranging spatial pixels in the initial high-frequency information to a channel dimension, to obtain high-frequency information matched with the low-frequency information.

In the embodiment of the present disclosure, the original image may be represented as (H, W, C); where, H represents height data of the original image, W represents width data of the original image, and C represents channel data of the original data; for example, C may be 3, representing that the channel data of the original image respectively includes 3 channels of RGB channels. For example, the original image is downsampled to obtain the low-frequency information of the original image; the obtained low-frequency information is directly upsampled to obtain the high-resolution low-frequency image corresponding to the low-frequency information; and the initial high-frequency information in the original image is determined based on the image data of the original image and the image data of the high-resolution low-frequency image. Exemplarily, the initial high-frequency information in the original image may be determined based on a difference between the image data of the above-described two images; for example, the original image and the high-resolution low-frequency image have a same resolution, pixel values of corresponding pixel points in the original image and the high-resolution low-frequency image respectively undergo difference processing, to obtain the initial high-frequency information. For example, spatial pixels in the initial high-frequency information are rearranged, and the spatial pixels are rearranged to the channel dimension, to obtain the high-frequency information matched with the low-frequency information, wherein the high-frequency information and the low-frequency information have a same resolution. For example, as shown in FIG. 2, the rearranging the spatial pixels in the initial high-frequency information to the channel dimension may be understood as reducing the height data and the width data in the initial high-frequency information, and meanwhile, arranging pixel data corresponding to a range exceeding the height data and the width data in other channels, so as to by increase the number of channel dimensions, to obtain the high-frequency information matched with the low-frequency information in resolution. Exemplarily, the low-frequency information may be represented as (H/2, W/2, C), and the high-frequency information may be represented as (H/2, W/2, 4 C).

It should be noted that the above-described matching may be understood as matching image resolutions of the low-frequency information and the high-frequency information, that is, matching the height data in the low-frequency information with the height data in the high-frequency information, and matching the width data in the low-frequency information with the width data in the high-frequency information. An advantageous effect of obtaining the high-frequency information matched with the low-frequency information in the technical solution of embodiment of the present disclosure is to facilitate the subsequent embedding of the content dependent information extracted from the high-frequency information into the low-frequency information. The embedding may be understood as storing the content dependent information in the original image into the low-frequency information in a hiding manner, to form a low-resolution image containing the high-frequency information related to the image content of the original image, which fully utilizes capability of the low-resolution image to invisibly store a large amount of information, and allows backward extraction of a portion of information related to the image content in the high-frequency information of the original image during subsequent upsampling of the low-resolution image to obtain the high-resolution image, to improve image quality of backward recovery of the image.

Exemplarily, an original image with a resolution of (H, W, C) undergoes 2 times downsampling, that is, 2 times downsampling by using bicubic interpolation, to obtain low-frequency information (H/2, W/2, C) of the original image; for example, the low-frequency information (H/2, W/2, C) undergoes 2 times upsampling by using bicubic interpolation, to obtain a high-resolution low-frequency image (H, W, C) having width data and length data the same as that of the original image; and image data of the high-resolution low-frequency image is subtracted from image data of the original image to obtain an initial high-frequency information of the original image; for example, spatial pixels in the initial high-frequency information are rearranged to a channel dimension, to obtain high-frequency information (H/2, W/2, 4 C) matched with the low-frequency information.

In some embodiments, the method of extracting the high-frequency information and the low-frequency information in the original image may further include: performing filtering transform on the original image to obtain the high-frequency information and the low-frequency information in the original image. The filtering transform may adopt wavelet transform, or may also adopt, for example, Haar transform, to perform high pass filter processing on input information, so as to obtain the high-frequency information and the low-frequency information separated from each other. For example, filtering transform is adopted to perform high pass filter processing on the image information in the original image, to obtain the high-frequency information and the low-frequency information of the original image. Exemplarily, filtering transform is adopted to perform information separation on the original image (H, W, C) through high pass filter, to respectively obtain low-frequency information (H/4, W/4, C) and high-frequency information (H/4, W/4, 15 C) after 4 times downsampling.

During the above-described downsampling process, multiples used for downsampling the original image include 2 times and 4×. It should be noted that the above-described sampling multiples are only exemplary embodiments for exemplary introduction. The technical solution of this embodiment may also adopt other sampling multiples, which will not be limited in this embodiment.

After obtaining the high-frequency information and the low-frequency information of the original image, the high-frequency information of the original image undergoes information extraction, to obtain the content dependent information in the high-frequency information; and the content dependent information is written into the low-frequency information, to obtain the corresponding low-resolution image of the original image.

It should be explained that the high-frequency information of the original image includes content dependent information and content independent information. The content dependent information may be understood as information related to the image content in the original image; the content independent information may be understood as other information such as image noise in the original image. For example, the method of extracting the content dependent information from the high-frequency information may be: extracting by using a pre-trained neural network model. For example, the high-frequency information may be processed based on a pre-trained information extraction model to obtain the content dependent information and the content independent information in the high-frequency information. For example, an information extraction model may be a network structure module; and the network structure of the information extraction model may be a structure such as a convolutional neural network, a multi-layer perceptron, which will not be limited.

On the basis of the above-described embodiments, the information extraction model may be an attention reversible transform network model. Correspondingly, the method of processing the high-frequency information based on the pre-trained information extraction model to obtain the content dependent information and the content independent information in the high-frequency information may include: inputting the high-frequency information and the low-frequency information into the attention reversible transform network model, to obtain the content dependent information and the content independent information in the high-frequency information, wherein, the low-frequency information is an auxiliary condition for extracting the content dependent information from the high-frequency information.

It should be noted that the low-frequency information contains the content information of the original image, that is, the low-frequency information serves as an auxiliary condition for extracting the content dependent information and is input into the attention reversible transform network model simultaneously with the high-frequency information; the content information contained in the low-frequency information may be taken as a learning target of the attention reversible transform network when extracting information, thus implementing accurate extraction of the image content information from the high-frequency information and the original image by the attention reversible transform network when extracting information.

Before adopting the attention reversible transform network model for information extraction, the attention reversible transform network model needs to undergo model training firstly. For example, the training method of the attention reversible transform network model may include: inputting high-frequency information in an original sample image into the attention reversible transform network model to be trained, to obtain content dependent information and content independent information output by the attention reversible transform network model; and backward inputting the content dependent information and the content independent information into the attention reversible transform network model to be trained, to obtain predicted high-frequency information backward output by the attention reversible transform network model; generating a loss function of the attention reversible transform network model to be trained based on the predicted high-frequency information and the high-frequency information in the original image, adjusting model parameters of the attention reversible transform network model to be trained based on the loss function; and iteratively executing the above-described training process until the trained attention reversible transform network model is obtained.

Exemplarily, the above-described high-frequency information (H/2, W/2, 4 C) matched with the low-frequency information obtained through the information separation further undergoes information extraction. For example, based on the attention reversible transform network model, the high-frequency information (H/2, W/2, 4 C) is separated into content dependent information (H/2, W/2, 4 pC) and content independent information (H/2, W/2, 4 C−4 pC) according to a separation ratio p. It should be noted that the above is an information separation case of 2 times downsampling the high-frequency information; a separation case of 4 times downsampling the high-frequency information (H/4, W/4, 15C) is content dependent information (H/4, W/4,15 pC) and content independent information (H/4, W/4, 15 C—15 pC). The separation ratio p is preset in the attention reversible transform network model and will not be limited. For example, the separation ratio p corresponding to 2 times downsampling is greater than the separation ratio p corresponding to 4 times downsampling. It should be noted that different downsampling multiples may correspond to different attention reversible transform network models.

In the embodiment of the present disclosure, after respectively obtaining the low-frequency information in the original image and the content dependent information of the high-frequency information in the original image, the content dependent information is further written into the low-frequency information to obtain the low-resolution image corresponding to the original image. For example, the method of writing the content dependent information into the low-frequency information to obtain the low-resolution image corresponding to the original image may include: performing data fusion on the content dependent information and the low-frequency information in the channel dimension, to obtain the low-resolution image corresponding to the original image.

For example, in order to obtain the high-frequency information matched with the low-frequency information, the spatial pixels of the initial high-frequency information in the original image are rearranged to the channel dimension, so that the height data and the width data of the subsequently obtained high-frequency information are respectively matched with those of the low-frequency information; the channel dimension of the high-frequency information is greater than the channel dimension of the low-frequency information, and correspondingly, the channel dimension of the content dependent information extracted in the high-frequency information is also greater than the channel dimension of the low-frequency information.

On this basis, the performing data fusion on the content dependent information and the low-frequency information in the channel dimension may include: determining first channel data in the low-frequency information, and at least one piece of second channel data in the corresponding content dependent information; and performing data fusion on the first channel data and the second channel data having correspondence.

In this embodiment, the channel data may be understood as pixel data of a plurality of channels; for example, the low-frequency information includes three first channels of RGB; the first channel data may be understood as R channel data, G channel data, and B channel data in the low-frequency information; the second channel data may be understood as pixel data of a plurality of channels in the content dependent information; it is worth noting that since the channel dimension of the content dependent information is greater than the channel dimension of the low-frequency information, correspondingly, the channel dimension of the first channel data is less than the channel dimension of the second channel data, thus, channel correspondence between the channel data of the first channel and the channel data of the second channel is a one-to-many relationship, that is, the first channel data in the low-frequency information and at least one piece of second channel data in the corresponding content dependent information need to be determined.

In this embodiment, the correspondence between the first channel data and the second channel data may be preset, and a mode of setting the correspondence will not be limited. For example, channels of a same type in the first channel data and the second channel data have correspondence; exemplarily, the first channel data includes three channels of RGB, and the second channel data respectively includes nine channels, that is, the numbers of RGB channels are respectively three. Correspondingly, the R channel in the first channel data corresponds to the three R channels in the second channel data, the G channel in the first channel data corresponds to the three G channels in the second channel data, and the B channel in the first channel data corresponds to the three B channels in the second channel data. For example, the plurality of channels in the first channel data correspond to the plurality of channels in the second channel data sequentially in polling at intervals. Exemplarily, the resolution of the low-frequency information is (H/2, W/2, C), and the channel dimension of the first channel data may be understood as 3 channels; the content dependent information is (H/2, W/2, 4 pC), and the channel dimension of the second channel data may be understood as 9 channels, by illustrating the preset separation ratio p as 75%. The correspondence between the 3 channels in the first channel data and the 9 channels in the second channel data is determined. The correspondence may be as follow: a first channel in the first channel data corresponds to a first channel, a fourth channel, and a seventh channel in the second channel data; a second channel in the first channel data corresponds to a second channel, a fifth channel, and an eighth channel in the second channel data; and a third channel in the first channel data corresponds to a third channel, a sixth channel, and a ninth channel in the second channel data. For example, the plurality of channels in the first channel data correspond to the plurality of channels in the second channel data sequentially in groups; with respect to a resolution of (H/2, W/2, C) for the low-frequency information and the content dependent information is (H/2, W/2, 4 pC), the correspondence thereof may also be as follows: the first channel in the first channel data corresponds to the first channel to the third channel in the second channel data; the second channel in the first channel data corresponds to the fourth channel to the sixth channel in the second channel data; and the third channel in the first channel data corresponds to the seventh channel to the ninth channel in the second channel data. Of course, there may also be other correspondence, which will not be limited in this embodiment.

For example, after determining the channel correspondence between the first channel data and the second channel data, data fusion is performed on the channel data in the first channel data and the channel data in the second channel data having correspondence, to obtain the low-resolution image corresponding to the original image. For example, in the case of 2 times downsampling, the process of obtaining the low-resolution image may include: ((H/2, W/2, C), (H/2, W/2, 4 pC))→(H/2, W/2, C); and in the case of 4 times downsampling, the process of obtaining the low-resolution image may include: ((H/4, W/4, C), (H/2, W/2, 15pC))→(H/4, W/4, C).

On the basis of the above-described embodiments, after extracting the content independent information of the high-frequency information, in the technical solution of this embodiment, the content independent information is further mapped to a standard normal distribution. The standard normal distribution may be understood as a normal distribution with a mean of 0 and a variance of 1. An effect of mapping the content independent information to a normal distribution lies in that: during the process of upsampling the low-resolution image to the original image, information may be extracted from the normal distribution, and the extracted information may be taken as image noise information of the original image for image processing, thereby recovering a high-resolution image more approximate to the original image. Of course, in some embodiments, the content independent information may not be processed; and correspondingly, in the process of upsampling the low-resolution image to recover the original image, information extraction may be directly performed based on the standard normal distribution, and image processing is performed on the extracted noise data and the low-resolution image, to obtain the high-resolution image.

The technical solution of the embodiment of the present disclosure involves: acquiring the original image, and extracting the high-frequency information and the low-frequency information in the original image; extracting the content dependent information in the high-frequency information, and writing the content dependent information into the low-frequency information, to obtain the low-resolution image corresponding to the original image. The above-described technical solution involves performing information extraction on the original image to obtain the high-frequency information of the original image; decomposing the high-frequency information, to extract the content dependent information about the original image from the high-frequency information, and writing the content dependent information as embedding information into the downsampled low-resolution image, so as to obtain the high-resolution image carrying more texture details, in the process of backward upsampling the low-resolution image, and improve image quality while reducing the amount of image data.

FIG. 3 is a schematic flow chart of another image processing method provided by an embodiment of the present disclosure. The method may be executed by the image processing apparatus provided by the embodiment of the present disclosure; the image processing apparatus may be implemented in a form of software and/or hardware, for example, implemented through an electronic device; and the electronic device may be a mobile terminal or a PC terminal, etc. As shown in FIG. 3, the method according to this embodiment includes:

S210: acquiring a low-resolution image; and extracting low-frequency information and content dependent information in high-frequency information based on the low-resolution image.

S220: determining the high-frequency information based on the content dependent information, and fusing the high-frequency information and the low-frequency information to obtain an original image corresponding to the low-resolution image.

In the embodiment of the present disclosure, in order to obtain the original image corresponding to the low-resolution image, the obtained low-resolution image needs to be upsampled to obtain a high-resolution original image.

For example, in order to obtain the original image corresponding to the low-resolution image, information extraction needs to be performed on the low-resolution image firstly, to respectively extract the low-frequency information and the content dependent information in the high-frequency information in the low-resolution image. The content dependent information includes some high-frequency information embedded into the low-resolution image during the process of downsampling the original image to obtain the low-resolution image. It should be noted that the process of extracting the low-frequency information and the content dependent information from the low-resolution image is reversible to the process of embedding the content dependent information into the low-frequency information according to the above-described embodiments, and processing modes of the two have correspondence.

In some embodiments, the method for extracting the low-frequency information and the content dependent information in the high-frequency information based on the low-resolution image may include: determining correspondence between data channels in the low-frequency information and data channels in the low-resolution image, and determining first channel data of the low-frequency information based on the channel data in the low-resolution image; determining correspondence between data channels in the content dependent information and data channels in the low-resolution image, and determining the second channel data of the content dependent information based on the channel data in the low-resolution image.

For example, the low-resolution image being obtained by performing data fusion in the channel dimension based on the low-frequency information and the content dependent information, may be understood as being obtained by performing data fusion based on the channel data of the low-frequency information and the channel data of the content dependent information having correspondence. Correspondingly, in the process of extracting the low-frequency information and the content dependent information in the low-resolution image, it is necessary to determine the correspondence between the data channels in the low-frequency information and the data channels in the low-resolution image, as well as the correspondence between the data channels in the content dependent information and the data channels in the low-resolution image. The first channel data of the low-frequency information is determined based on the channel data in the low-resolution image, and the second channel data of the content dependent information is determined based on the channel data in the low-resolution image.

It is worth noting in the technical solution of embodiment of the present disclosure that the determining the first channel data and the determining the second channel data are executed non-sequentially, but may be executed sequentially or simultaneously, which will not be limited in this embodiment.

Exemplarily, if the resolution of the low-resolution image is (H/2, W/2, C), then in a case of C=3, it may be understood that the channel dimension of the low-resolution image is 3 channels. For example, correspondence between data channels in the low-frequency information and data channels in the low-resolution image is acquired, if the correspondence between data channels thereof is one-to-one correspondence, then the channel dimension of the low-frequency information in the corresponding low-resolution image is also 3 channels, the resolution of the low-frequency information is (H/2, W/2, C); and the first channel data (H/2, W/2, C) in the low-frequency information is correspondingly determined based on the channel data in the low-resolution image.

For example, the method of determining the first channel data may be: performing data replication on the channel data in the low-resolution image, and taking the same as the first channel data of the corresponding data channel in the low-frequency information.

For example, correspondence between data channels in the content dependent information and data channels in the low-resolution image is acquired. For example, the correspondence may be as follows: the first channel, the fourth channel, and the seventh channel in the content dependent information correspond to the first channel in the low-resolution image; channel data of the first channel, the fourth channel, and the seventh channel in the second channel data is respectively determined based on the channel data of the first channel in the low-resolution image; and channel data of other channels in the second channel data is correspondingly determined based on channel correspondence between the other channels. For example, the correspondence may also be as follows: the first channel to the third channel in the content dependent information correspond to the first channel in the low-resolution image; channel data of the first channel to the third channel in the second channel data is respectively determined based on the channel data of the first channel in the low-resolution image, and channel data of other channels in the second channel data is correspondingly determined based on channel correspondence between the other channels. Of course, the correspondence between data channels in the content dependent information and data channels in the low-resolution image may also be other correspondence; correspondingly, the second channel data of the content dependent information is determined based on other correspondence and the channel data in the low-resolution image, which will not be limited in this embodiment.

On the basis of the above-described embodiments, the method of determining the second channel data of the content dependent information based on the channel data in the low-resolution image may include: performing data replication on the channel data in the low-resolution image, and taking the same as the second channel data of the corresponding data channel in the content dependent information.

In some embodiments, the method of determining the second channel data of the content dependent information based on the channel data in the low-resolution image may further include: taking random values of the channel data in the low-resolution image within a preset range as the second channel data of the corresponding data channel in the content dependent information. Exemplarily, it will be introduced by taking that the channel data of the first channel to the third channel in the second channel data is respectively determined based on the channel data of the first channel in the low-resolution image an example: any piece of data in the first channel in the low-resolution image, for example, may be 230, a preset range of the data may be 230±5; correspondingly, the corresponding data in the first channel to the third channel in the second channel data may be randomly sampled within the range of 230±5, for example, within the second channel data, the corresponding data in the first channel may be 232, the corresponding data in the second channel may be 235, and the corresponding in the third channel data may be 228. For example, the second channel data of the corresponding data channel in the content dependent information may be represented as (H/2, W/2, 4 pC).

In this embodiment, in order to determine the high-frequency information corresponding to the low-resolution image based on the content dependent information, and to improve authenticity of high-resolution data recovered, it is necessary to acquire content independent data and determine the high-frequency information based on content dependent data and the content independent data. For example, the method for determining the content independent data may include: performing information resampling in a preset data distribution corresponding to the content independent information, to obtain the content independent information. The preset data distribution may be understood as a normal distribution to which the content independent information of the high-frequency information in the original image is mapped during the process of downsampling the original data to obtain the low-resolution image; of course, other preset data distributions may also be selected for use, which will not be limited in this embodiment.

For example, the content independent information is extracted from above-described mapped normal distribution; the extracted information is taken as image noise information of the original image, and is resampled together with the content dependent image, to obtain the high-frequency information corresponding to the low-resolution image. Of course, in some embodiments, information may also be extracted directly based on the standard normal distribution, and the content independent information and the content dependent information are resampled, to obtain the high-frequency information.

In some embodiments, the method for resampling the content independent information and the content dependent information, to obtain the high-frequency information may include: backward inputting the content dependent information and the content independent information into the attention reversible transform network model, to obtain the high-frequency information output by the attention reversible transform network model.

Exemplarily, with respect to the content dependent information extracted from the low-resolution image, in the case of 2 times upsampling, the content dependent information is represented as (H/2, W/2, 4 pC); and in the case of 4 times upsampling, the content dependent information is represented as (H/2, W/2, 15 pC). For example, if the obtained content independent information is 2 times upsampled, the content independent information is represented as (H/2, W/2, 4 C−4 pC); if the obtained content independent information is 4× upsampled, the content independent information is represented as (H/4, W/4, 15 C−15 pC). For example, in the case of 2 times downsampling, the process of obtaining the high-frequency information may include ((H/2, W/2, 4 C−4 pC), (H/2, W/2, 4 pC))→(H/2, W/2, 4 C); and in the case of 4 times downsampling, the process of obtaining the low-resolution image may include: ((H/2, W/2, 15 pC), (H/2, W/2, 15 pC))→(H/4, W/4, 15 C).

For example, after obtaining the low-frequency information and the high-frequency information of the low-resolution image, the original image corresponding to the low-resolution image is obtained by fusing the high-frequency information and the low-frequency information. For example, the method of obtaining the original image corresponding to the low-resolution image may include: upsampling the low-frequency information to obtain the high-resolution low-frequency image; performing spatial inverse rearrangement on the channel data of the high-frequency information to obtain a high-resolution high-frequency image; and obtaining the original image based on the high-resolution low-frequency image and the high-resolution high-frequency image.

For example, the obtained low-frequency information is directly upsampled to obtain the high-resolution low-frequency image corresponding to the low-frequency information; and spatial inverse rearrangement is performed on data channels in the high-frequency information to obtain the high-resolution high-frequency image corresponding to the high-frequency information; for example, image fusion is performed on the high-resolution low-frequency image and the high-resolution high-frequency image, to obtain the original image corresponding to the low-resolution image.

Exemplarily, the original image with a resolution of (H/2, W/2, C) is 2 times upsampled, that is, 2 times upsampling by using bicubic interpolation, to obtain the high-resolution low-frequency image (H, W, C); spatial inverse rearrangement is performed on the high-frequency information (H/2, W/2, 4 C) to obtain the high-resolution high-frequency image (H, W, C) having width data and length data the same as those of the high-resolution low-frequency image; and further, image fusion is performed on the high-resolution low-frequency image and the high-resolution high-frequency image to obtain the original image (H, W, C) corresponding to the low-resolution image.

In some embodiments, the method for obtaining the original image corresponding to the low-resolution image may further include: performing inverse Haar transform on the high-frequency information and the low-frequency information, to obtain the original image.

Exemplarily, information fusion is performed on the low-frequency information (H/4, W/4, C) and the high-frequency information (H/4, W/4, 15 C) by using inverse Haar transform, to obtain the original image (H, W, C) corresponding to the low-resolution image.

The technical solution of the embodiment of the present disclosure involves acquiring the low-resolution image, and extracting the low-frequency information and the content dependent information in the high-frequency information based on the low-resolution image; determining the high-frequency information based on the content dependent information, and fusing the high-frequency information and the low-frequency information to obtain the original image corresponding to the low-resolution image. Through the above-described technical solution, the high-resolution image carrying more texture details is obtained, thereby improving image quality.

On the basis of the above-described embodiments, an embodiment of the present disclosure further provides an application embodiment for explaining the steps of obtaining a low-resolution image based on a high-resolution image, and further backward obtaining the high-resolution image based on the low-resolution image.

Before introducing the following application embodiment, an adaptive introduction to application scenarios of the embodiment is provided firstly. For example, this interactive embodiment may be applicable to a process of image transmission, exemplarily, which may be data transmission between a client and a server, for example, the client requests the server to issue an image/video, correspondingly, before transmitting the image/video, the server firstly processes a plurality of video frames (i.e., high-resolution images) in the image or the video to be transmitted based on the mode of the above-described embodiments, to obtain a corresponding low-resolution image/video, and transmits the low-resolution image/video, to reduce the amount of transmitted data, and thus reduce transmission costs; and after receiving the low-resolution image/video issued by the server, the client respectively processes the plurality of image frames in the low-resolution image or the low-resolution video based on the processing mode provided by the above-described embodiments, to obtain a high-resolution image/video corresponding to the low-resolution image/video for image display. Of course, the above-described image/video transmission may also be image transmission between clients, which will not be limited in this embodiment. For example, the application embodiment may also be applicable to a process of image/video storage. Exemplarily, during the process of local storage of an image, the client may process image frames in the image to be stored or the video to be stored based on the processing mode provided by the above-described embodiments, to obtain a low-resolution image/video, and then store the low-resolution image/video; when it is necessary to process or display the stored image/video, the image frames in the low-resolution image or the low-resolution video may be processed based on the processing mode provided by the above-described embodiments, to obtain a corresponding high-resolution image/video, for subsequent display or processing.

The above-described application scenarios are only exemplary application scenarios according to this application embodiment; and this embodiment may also be applied to other application scenarios, and no details will be repeated in this embodiment.

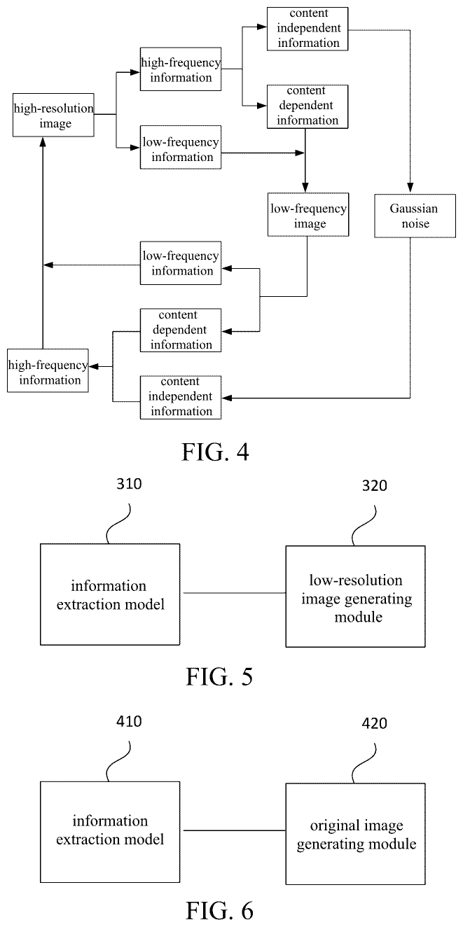

As shown in FIG. 4, the application embodiment includes steps of:

Step One: performing high/low-frequency information separation on the high-resolution image (the original image), to respectively obtain the high-frequency information and the low-frequency information.

Step Two: performing information separation on the high-frequency information, to respectively obtain content dependent information and content independent information.

Step Three: embedding the content dependent information into the low-frequency information, to obtain a low-resolution image corresponding to the high-resolution image.

Step Four: mapping the content independent information as Gaussian noise.

Step Five: performing information extraction on the low-resolution image, to respectively obtain content dependent information in the low-frequency information and the high-frequency information.

Step Six: resampling the Gaussian noise, to obtain content independent information.

Step Seven: performing information fusion on the content independent information and the content dependent information, to obtain the high-frequency information.

Step Eight: performing high/low-frequency information fusion on the high-frequency information and the low-frequency information, to obtain the high-resolution image.

It is worth noting that among the above-described plurality of steps, step One to step Four may be executed with a same apparatus, for example, a server; and meanwhile, step Five to step Eight may be executed with another apparatus, for example, a client; or, step One to step Eight may all be executed with a same apparatus, for example, a server or a client; and an apparatus for executing the plurality of steps will not be limited in this embodiment.

FIG. 5 is a structural schematic diagram of an image processing apparatus provided by an embodiment of the present disclosure. As shown in FIG. 5, the apparatus includes: an information extraction model 310 and a low-resolution image generating module 320.

The information extraction model 310 is configured to acquire an original image, and extract high-frequency information and low-frequency information in the original image;

The low-resolution image generating module 320 is configured to extract content dependent information in the high-frequency information, and write the content dependent information into the low-frequency information, to obtain a low-resolution image corresponding to the original image.

In the technical solution of the embodiment of the present disclosure,

On the basis of the above-described embodiments, the low-resolution image generating module 320 includes:

an information extracting submodule, configured to process the high-frequency information based on a pre-trained information extraction model, to obtain content dependent information and content independent information in the high-frequency information.

On the basis of the above-described embodiments, the information extraction model is an attention reversible transform network model;

Correspondingly, the information extracting submodule includes:

an information extracting unit, configured to input the high-frequency information and the low-frequency information into the attention reversible transform network model, to obtain the content dependent information and the content independent information in the high-frequency information; wherein, the low-frequency information is an auxiliary condition for extracting the content dependent information from the high-frequency information.

On the basis of the above-described embodiments, the low-resolution image generating module 320 includes:

a data fusing submodule, configured to perform data fusion on the content dependent information and the low-frequency information in a channel dimension, to obtain a low-resolution image corresponding to the original image.

On the basis of the above-described embodiments, the data fusing submodule includes:

a data fusing unit, configured to determine first channel data in the low-frequency information, and at least one piece of second channel data in the corresponding content dependent information; and perform data fusion between the first channel data and the second channel data having correspondence.

On the basis of the above-described embodiments, the information extraction model 310 includes:

a first information extracting unit, configured to downsample the original image to obtain the low-frequency information; determine initial high-frequency information based on the original image and the high-resolution low-frequency image obtained by upsampling the low-frequency information; and rearrange spatial pixels in the initial high-frequency information to the channel dimension, to obtain high-frequency information matched with the low-frequency information;

or,

a second information extracting unit, configured to perform filtering transform on the original image, to obtain the high-frequency information and the low-frequency information in the original image.

FIG. 6 is a structural schematic diagram of another image processing apparatus provided by an embodiment of the present disclosure. As shown in FIG. 6, the apparatus includes: an information extraction model 410 and an original image generating module 420.

The information extraction model 410 is configured to acquire a low-resolution image, and extract content dependent information in low-frequency information and high-frequency information based on the low-resolution image;

The original image generating module 420 is configured to determine the high-frequency information based on the content dependent information, and fuse the high-frequency information and the low-frequency information to obtain the original image corresponding to the low-resolution image. In the technical solution of the embodiment of the present disclosure,

On the basis of the above-described embodiments, the information extraction model 410 includes:

a first channel data determining submodule, configured to determine correspondence between data channels in the low-frequency information and data channels in the low-resolution image, and determine first channel data of the low-frequency information based on the channel data in the low-resolution image;

a second channel data determining submodule, configured to determine correspondence between data channels in the content dependent information and the data channels in the low-resolution image, and determine second channel data of the content dependent information based on the channel data in the low-resolution image.

On the basis of the above-described embodiments, the first channel data determining submodule includes:

a first channel data determining unit, configured to perform data replication on the channel data in the low-resolution image, and take the same as the first channel data of the corresponding data channel in the low-frequency information;

a second channel data determining submodule, including:

a second channel data determining unit, configured to perform data replication on the channel data in the low-resolution image, and take the same as the second channel data of the corresponding data channel in the content dependent information.

On the basis of the above-described embodiments, the apparatus further includes:

an information acquiring module, configured to perform information resampling in a preset data distribution corresponding to the content independent information, to obtain the content independent information, before determining the high-frequency information based on the content dependent information;

Correspondingly, the information extraction model 410, includes:

a high-frequency information determining submodule, configured to determine the high-frequency information based on the content dependent information and the content independent information obtained through resampling.

On the basis of the above-described embodiments, the high-frequency information determining submodule, includes:

a high-frequency information determining unit, configured to backward input the content dependent information and the content independent information into the attention reversible transform network model, to obtain the high-frequency information output by the attention reversible transform network model.

On the basis of the above-described embodiments, the original image generating module 420, includes:

a first original image generating unit, configured to upsample the low-frequency information to obtain a high-resolution low-frequency image; perform spatial inverse rearrangement on the channel data of the high-frequency information, to obtain a high-resolution high-frequency image; and obtain the original image based on the high-resolution low-frequency image and the high-resolution high-frequency image;

or,

a second original image generating unit, configured to perform inverse Haar transform on the high-frequency information and the low-frequency information, to obtain the original image.

The apparatus provided by the embodiment of the present disclosure may execute the method provided by any embodiment of the present disclosure, and has corresponding functional modules and advantageous effects for executing the method.

It is worth noting that the plurality of units and modules included in the above-described apparatus are only divided according to functional logic, but are not limited to the above-described division, as long as the corresponding functions may be implemented; in addition, specific names of the plurality of functional units are only intended to facilitate distinguishing them from each other, and are not used to limit the scope of protection of the embodiments of the present disclosure.

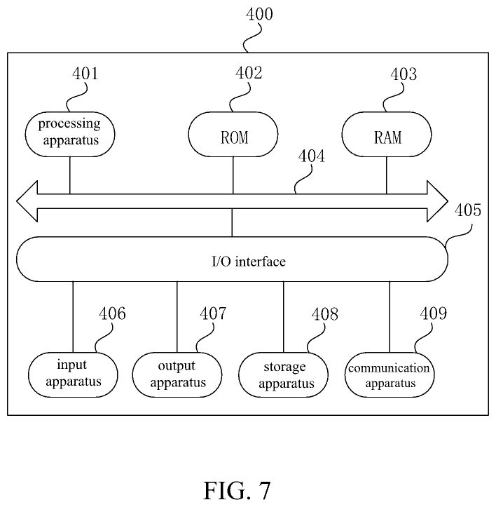

Hereinafter, referring to FIG. 7, it shows a structural schematic diagram of an electronic device (e.g., the terminal device or the server in FIG. 7) 400 suitable for implementing the embodiment of the present disclosure. The terminal device according to the embodiment of the present disclosure may include but not limited to a mobile terminal such as a mobile phone, a laptop, a digital broadcast receiver, a personal digital assistant (PDA), a portable android device (PAD), a portable multimedia player (PMP), a vehicle-mounted terminal (e.g., a vehicle-mounted navigation terminal), and a fixed terminal such as a digital TV, a desktop computer. The electronic device shown in FIG. 7 is only an example and should not impose any limitation on functionality and scope of use of the embodiment of the present disclosure.

As shown in FIG. 7, the electronic device 400 may include a processing apparatus (e.g., a central processing unit, a graphics processing unit, etc.) 401, which may execute various appropriate actions and processing according to a program stored in a read-only memory (ROM) 402 or a program loaded from a storage apparatus 408 into a random access memory (RAM) 403. The RAM 403 further stores various programs and data required for operation of the electronic device 400. The processing apparatus 401, the ROM 402, and the RAM 403 are connected with each other through a bus 404. An input/output (I/O) interface 405 is also coupled to the bus 404.

Usually, apparatuses below may be coupled to the I/O interface 405: an input apparatus 406 including, for example, a touch screen, a touch pad, a keyboard, a mouse, a camera, a microphone, an accelerometer, a gyroscope; an output apparatus 407 including, for example, a liquid crystal display (LCD), a speaker, a vibrator.; a storage apparatus 408 including, for example, a magnetic tape, a hard disk; and a communication apparatus 409. The communication apparatus 409 may allow the electronic device 400 to perform wireless or wired communication with other device so as to exchange data. Although FIG. 7 shows the electronic device 400 including various apparatuses, it should be understood that, it is not required to implement or have all the apparatuses shown, and the electronic device 400 may alternatively implement or have more or fewer apparatuses.

According to the embodiments of the present disclosure, the process described above with reference to a flow chart may be implemented as computer software programs. For example, the embodiments of the present disclosure include a computer program product, including a computer program carried on a non-temporary computer readable medium, the computer program including program codes for executing the method shown in the flow chart. In such embodiments, the computer program may be downloaded and installed from the network via the communication apparatus 409, or installed from the storage apparatus 408, or installed from the ROM 402. When executed by the processing apparatus 401, the computer program may execute the above-described functions defined in the method according to the embodiment of the present disclosure.

The electronic device provided by the embodiment of the present disclosure and the holographic projection model method provided by the above-described embodiment belong to a same concept. The above-described embodiments may be referred to for technical details not described in detail in this embodiment; and this embodiment has the same advantageous effects as the above-described embodiments.

An embodiment of the present disclosure provides a computer storage medium, having a computer program stored thereon, wherein, the program, when executed by a processor, implements the image processing method provided by the above-described embodiments.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs. The above-mentioned one or more programs, when executed by the electric device, causes the electric device to:

acquire an original image, and extract high-frequency information and low-frequency information in the original image;

extract content dependent information in the high-frequency information, and write the content dependent information into the low-frequency information, to obtain a low-resolution image corresponding to the original image,

or

acquire a low-resolution image, and extract content dependent information in low-frequency information and high-frequency information based on the low-resolution image;

determine the high-frequency information based on the content dependent information, and fuse the high-frequency information and the low-frequency information to obtain the original image corresponding to the low-resolution image.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

According to one or more embodiments of the present disclosure, [Example 1] provides an image processing method, including:

acquiring an original image, and extracting high-frequency information and low-frequency information in the original image;

extracting content dependent information in the high-frequency information, and writing the content dependent information into the low-frequency information, to obtain a low-resolution image corresponding to the original image.

According to one or more embodiments of the present disclosure, [Example 2] provides an image processing method, wherein,

the extracting content dependent information in the high-frequency information, includes:

processing the high-frequency information based on a pre-trained information extraction model, to obtain the content dependent information and content independent information in the high-frequency information.

According to one or more embodiments of the present disclosure, [Example 3] provides an image processing method, wherein, the information extraction model is an attention reversible transform network model;

the processing the high-frequency information based on a pre-trained information extraction model, to obtain the content dependent information and content independent information in the high-frequency information, includes:

inputting the high-frequency information and the low-frequency information into the attention reversible transform network model, to obtain the content dependent information and the content independent information in the high-frequency information; wherein the low-frequency information is an auxiliary condition for extracting the content dependent information from the high-frequency information.

According to one or more embodiments of the present disclosure, [Example 4] provides an image processing method, wherein,

the writing the content dependent information into the low-frequency information, to obtain a low-resolution image corresponding to the original image, includes:

performing data fusion on the content dependent information and the low-frequency information in a channel dimension, to obtain the low-resolution image corresponding to the original image.

According to one or more embodiments of the present disclosure, [Example 5] provides an image processing method, wherein,

the performing data fusion on the content dependent information and the low-frequency information in a channel dimension, includes:

determining first channel data in the low-frequency information, and at least one piece of second channel data in the corresponding content dependent information; and performing data fusion on the first channel data and the second channel data having correspondence.

According to one or more embodiments of the present disclosure, [Example 6] provides an image processing method, wherein,

the extracting high-frequency information and low-frequency information in the original image, includes:

downsampling the original image to obtain the low-frequency information; determining initial high-frequency information based on the original image and a high-resolution low-frequency image obtained by upsampling the low-frequency information; and rearranging spatial pixels in the initial high-frequency information to a channel dimension, to obtain high-frequency information matched with the low-frequency information;

or,

performing filtering transform on the original image, to obtain the high-frequency information and the low-frequency information in the original image.

According to one or more embodiments of the present disclosure, [Example 7] provides an image processing method, including:

acquiring a low-resolution image, and extracting content dependent information in low-frequency information and high-frequency information based on the low-resolution image;

determining the high-frequency information based on the content dependent information, and fusing the high-frequency information and the low-frequency information to obtain the original image corresponding to the low-resolution image.

According to one or more embodiments of the present disclosure, [Example 8] provides an image processing method, wherein,

the extracting content dependent information in low-frequency information and high-frequency information based on the low-resolution image, includes:

determining correspondence between data channels in the low-frequency information and data channels in the low-resolution image, and determining first channel data of the low-frequency information based on channel data in the low-resolution image; and

determining correspondence between data channels in the content dependent information and the data channels in the low-resolution image, and determining the second channel data of the content dependent information based on the channel data in the low-resolution image.

According to one or more embodiments of the present disclosure, [Example 9] provides an image processing method, wherein,

the determining the first channel data of the low-frequency information based on the channel data in the low-resolution image, includes:

performing data replication on the channel data in the low-resolution image, and taking the same as the first channel data of the corresponding data channel in the low-frequency information;

and, the determining the second channel data of the content dependent information based on the channel data in the low-resolution image, includes:

performing data replication on the channel data in the low-resolution image, and taking the same as the second channel data of the corresponding data channel in the content dependent information.

According to one or more embodiments of the present disclosure, [Example 10] provides an image processing method, wherein, before the determining the high-frequency information based on the content dependent information, the method further includes:

performing information resampling in a preset data distribution corresponding to the content independent information, to obtain the content independent information;

Correspondingly, the determining the high-frequency information based on the content dependent information, includes:

determining the high-frequency information based on the content dependent information and the content independent information obtained through resampling.

According to one or more embodiments of the present disclosure, [Example 11] provides an image processing method, wherein,

the determining the high-frequency information based on the content dependent information and the content independent information obtained through resampling, includes:

backward inputting the content dependent information and the content independent information into the attention reversible transform network model, to obtain the high-frequency information output by an attention reversible transform network model.

According to one or more embodiments of the present disclosure, [Example 12] provides an image processing method, wherein,

the fusing the high-frequency information and the low-frequency information to obtain the original image corresponding to the low-resolution image, includes:

upsampling the low-frequency information to obtain a high-resolution low-frequency image; performing spatial inverse rearrangement on channel data of the high-frequency information, to obtain a high-resolution high-frequency image; and obtaining the original image based on the high-resolution low-frequency image and the high-resolution high-frequency image;

or,

performing inverse Haar transform on the high-frequency information and the low-frequency information, to obtain the original image.

According to one or more embodiments of the present disclosure, [Example 13] provides an image processing apparatus, including:

an information extraction model, configured to acquire an original image, and extract high-frequency information and low-frequency information in the original image;

a low-resolution image generating module, configured to extract content dependent information in the high-frequency information, and write the content dependent information into the low-frequency information, to obtain a low-resolution image corresponding to the original image.

According to one or more embodiments of the present disclosure, [Example 14] provides an image processing apparatus, including:

an information extraction model, configured to acquire a low-resolution image, and extract content dependent information in low-frequency information and high-frequency information based on the low-resolution image; and

an original image generating module, configured to determine the high-frequency information based on the content dependent information, and fuse the high-frequency information and the low-frequency information to obtain the original image corresponding to the low-resolution image.

In addition, while operations have been described in a particular order, it shall not be construed as requiring that such operations are performed in the stated specific order or sequence. Under certain circumstances, multitasking and parallel processing may be advantageous.

Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

1. An image processing method, comprising:
acquiring an original image, and extracting high-frequency information and low-frequency information in the original image;
extracting content dependent information in the high-frequency information, and writing the content dependent information into the low-frequency information, to obtain a low-resolution image corresponding to the original image.

2. The method according to claim 1, wherein the extracting content dependent information in the high-frequency information, comprises:
processing the high-frequency information based on a pre-trained information extraction model, to obtain the content dependent information and content independent information in the high-frequency information.

3. The method according to claim 2, wherein the information extraction model is an attention reversible transform network model;
the processing the high-frequency information based on a pre-trained information extraction model, to obtain the content dependent information and content independent information in the high-frequency information, comprises:
inputting the high-frequency information and the low-frequency information into the attention reversible transform network model, to obtain the content dependent information and the content independent information in the high-frequency information, wherein the low-frequency information is an auxiliary condition for extracting the content dependent information from the high-frequency information.

4. The method according to claim 1, wherein the writing the content dependent information into the low-frequency information, to obtain a low-resolution image corresponding to the original image, comprises:
performing data fusion on the content dependent information and the low-frequency information in a channel dimension, to obtain the low-resolution image corresponding to the original image.

5. The method according to claim 4, wherein the performing data fusion on the content dependent information and the low-frequency information in a channel dimension, comprises:
determining first channel data in the low-frequency information, and at least one piece of second channel data in the corresponding content dependent information; and performing data fusion on the first channel data and the second channel data having correspondence.

6. The method according to claim 1, wherein the extracting high-frequency information and low-frequency information in the original image, comprises:
downsampling the original image to obtain the low-frequency information; determining initial high-frequency information based on the original image and a high-resolution low-frequency image obtained by upsampling the low-frequency information; and rearranging spatial pixels in the initial high-frequency information to a channel dimension, to obtain high-frequency information matched with the low-frequency information;
or,
performing filtering transform on the original image, to obtain the high-frequency information and the low-frequency information in the original image.

7. An image processing method, comprising:
acquiring a low-resolution image, and extracting content dependent information in low-frequency information and high-frequency information based on the low-resolution image;
determining the high-frequency information based on the content dependent information, and fusing the high-frequency information and the low-frequency information to obtain the original image corresponding to the low-resolution image.

8. The method according to claim 7, wherein the extracting content dependent information in low-frequency information and high-frequency information based on the low-resolution image, comprises:
determining correspondence between data channels in the low-frequency information and data channels in the low-resolution image, and determining first channel data of the low-frequency information based on channel data in the low-resolution image; and
determining correspondence between data channels in the content dependent information and the data channels in the low-resolution image, and determining the second channel data of the content dependent information based on the channel data in the low-resolution image.

9. The method according to claim 8, wherein, the determining the first channel data of the low-frequency information based on the channel data in the low-resolution image, comprises:
performing data replication on the channel data in the low-resolution image, and taking the same as the first channel data of the corresponding data channel in the low-frequency information; and,
the determining the second channel data of the content dependent information based on the channel data in the low-resolution image, comprises:
performing data replication on the channel data in the low-resolution image, and taking the same as the second channel data of the corresponding data channel in the content dependent information.

10. The method according to claim 7, wherein before the determining the high-frequency information based on the content dependent information, the method further comprises:
performing information resampling in a preset data distribution corresponding to the content independent information, to obtain the content independent information;
the determining the high-frequency information based on the content dependent information, comprises:
determining the high-frequency information based on the content dependent information and the content independent information obtained through resampling.

11. The method according to claim 10, wherein the determining the high-frequency information based on the content dependent information and the content independent information obtained through resampling, comprises:
backward inputting the content dependent information and the content independent information into the attention reversible transform network model, to obtain the high-frequency information output by an attention reversible transform network model.

12. The method according to claim 7, wherein the fusing the high-frequency information and the low-frequency information to obtain the original image corresponding to the low-resolution image, comprises:
upsampling the low-frequency information to obtain a high-resolution low-frequency image; performing spatial inverse rearrangement on channel data of the high-frequency information, to obtain a high-resolution high-frequency image; and obtaining the original image based on the high-resolution low-frequency image and the high-resolution high-frequency image;
or,
performing inverse Haar transform on the high-frequency information and the low-frequency information, to obtain the original image.

13-14. (canceled)

15. An electronic device, comprising:
one or more processors;
at least one storage apparatus, configured to store one or more programs,
wherein the one or more programs, when executed by the one or more processors, cause the one or more processors to implement an image processing method, comprising:
acquiring an original image, and extracting high-frequency information and low-frequency information in the original image;
extracting content dependent information in the high-frequency information, and writing the content dependent information into the low-frequency information, to obtain a low-resolution image corresponding to the original image.

16. A non-transient computer-readable storage medium, comprising computer executable instructions, wherein the computer executable instructions, when executed by a computer processor, are configured to execute the image processing method according to claim 1.

17. The electronic device according to claim 15, wherein the extracting content dependent information in the high-frequency information, comprises:
processing the high-frequency information based on a pre-trained information extraction model, to obtain the content dependent information and content independent information in the high-frequency information.

18. The electronic device according to claim 17, the information extraction model is an attention reversible transform network model;
the processing the high-frequency information based on a pre-trained information extraction model, to obtain the content dependent information and content independent information in the high-frequency information, comprises:
inputting the high-frequency information and the low-frequency information into the attention reversible transform network model, to obtain the content dependent information and the content independent information in the high-frequency information, wherein the low-frequency information is an auxiliary condition for extracting the content dependent information from the high-frequency information.

19. The electronic device according to claim 15, wherein the writing the content dependent information into the low-frequency information, to obtain a low-resolution image corresponding to the original image, comprises:
performing data fusion on the content dependent information and the low-frequency information in a channel dimension, to obtain the low-resolution image corresponding to the original image.

20. The electronic device according to claim 19, wherein the performing data fusion on the content dependent information and the low-frequency information in a channel dimension, comprises:
determining first channel data in the low-frequency information, and at least one piece of second channel data in the corresponding content dependent information; and performing data fusion on the first channel data and the second channel data having correspondence.

21. An electronic device, comprising:
one or more processors;
at least one storage apparatus, configured to store one or more programs,
wherein the one or more programs, when executed by the one or more processors, cause the one or more processors to implement the image processing method according claim 7.

22. A non-transient computer-readable storage medium, comprising computer executable instructions, wherein the computer executable instructions, when executed by a computer processor, are configured to execute the image processing method according to claim 7.
